(19) United States
(12) Patent Application Publication
(10) Pub. No.: US 2026/0029792 A1
(43) Pub. Date: Jan. 29, 2026

(54) AUTONOMOUS MOBILE ROBOT AND SYSTEM FOR CONTROLLING AUTONOMOUS MOBILE ROBOT

(71) Applicant: THK CO., LTD., Tokyo (JP)

(72) Inventors: Hitoshi Kitano, Tokyo (JP); Kosei Mochizuki, Tokyo (JP)

(73) Assignee: THK CO., LTD., Tokyo (JP)

(21) Appl. No.: 18/994,309

(22) PCT Filed: Jul. 14, 2023
(86) PCT No.: PCT/JP2023/026015

§ 371 Date: Jan. 14, 2025

(30) Foreign Application Priority Data
Jul. 15, 2022 (JP) 2022-113975

(51) Int. Cl. G05D 1/244; G05D 101/20; G06T 7/50; G06V 20/58

(52) U.S. Cl. CPC G05D 1/2446; G06T 7/50; G06V 20/582; G05D 2101/20; G06T 2207/30252

(57) ABSTRACT

The present invention is an autonomous mobile robot (1) that moves by being guided by a plurality of signs that have a plurality of types of sizes, are aligned along a movement path (10), and includes a first sign and a second sign, the autonomous mobile robot (1) including: an imaging unit (26); a storage unit (25) storing individual identification information of each of a plurality of signs and an individual actual size of each of the plurality of signs; and a calculation unit (27) calculating a distance (D1) to the first sign on the basis of a size of the first sign on image data captured by the imaging unit (26) and the individual actual size of the first sign corresponding to the individual identification information of the first sign.

### TECHNICAL FIELD

The present invention relates to an autonomous mobile robot and a system for controlling an autonomous mobile robot. Priority is claimed on Japanese Patent Application No. 2022-113975, filed Jul. 15, 2022, the content of which is incorporated herein by reference.

### BACKGROUND ART

Conventionally, a measurement device (digital camera) described in the following Patent Document 1 is known. This measuring device includes: an acquisition means for moving an imaging optical system imaging a subject image onto a predetermined imaging surface along an optical axis direction and acquiring image data from the subject image formed in the imaging optical system described above for each movement; an in-focus evaluation value calculating means for calculating an in-focus evaluation value on the basis of the image data described above; a target object detecting means for detecting a target object from the image data described above; a distance calculating means for calculating a distance to the above-described target object on the basis of a size of the target object described above; a distance measuring means for measuring a distance to the target object described above; a peak value detecting means for detecting a peak value from the calculated in-focus evaluation value described above; and a subject distance determining means for determining one of the distance to the above-described target object calculated by the distance calculating means described above or the distance to the target object measured by the distance measuring means described above as a subject distance on the basis of a magnitude of the detected peak value described above.

### CITATION LIST

### Patent Document

[Patent Document 1]

Japanese Patent No. 4444927

### SUMMARY OF INVENTION

### Technical Problem

In the conventional technology described above, in a case in which a subject distance is calculated from the size of a subject's face, when the size of the face is small, an error occurs between the calculated result (calculated subject distance) and an actual subject distance, and thus a correct subject distance cannot be obtained. For this reason, one of a distance calculated from the image data and a distance measured by the distance measuring sensor is determined as the subject distance. However, in a case in which the conventional technology described above is applied to an autonomous mobile robot that moves while being guided by signs aligned along a movement path, there are the following problems. In other words, in an autonomous mobile robot, a sign (subject) may not be present nearby. For example, if a sign is several to several tens of meters ahead from an autonomous mobile robot, it becomes difficult to measure a distance to the sign unless a distance measuring sensor with high accuracy is provided. In addition, signs that are disposed at a distance are frequently formed to have a size of a sign which is larger than a normal size of a sign such that autonomous mobile robots can detect the signs. In such a case, in a case in which a normal-sized sign close to an autonomous mobile robot and a larger-sized sign far from the autonomous mobile robot are simultaneously shown in image data captured by the autonomous mobile robot, the two signs, which are actually different in size from each other, may be displayed with the same size on the image data depending on the distance. As a result, there is a possibility that the autonomous mobile robot erroneously recognizes that distances from this autonomous mobile robot to the two signs are the same.

The present invention has been made in view of the problem described above, and an object thereof is to provide an autonomous mobile robot and a system for controlling an autonomous mobile robot that can accurately calculate a distance to a sign and perform guidance control, even if signs have a plurality of types of sizes.

### Solution to Problem

In order to solve the problems described above, a first aspect of the present invention is an autonomous mobile robot that moves by being guided by a plurality of signs that have a plurality of types of sizes, are aligned along a movement path, and include a first sign and a second sign. The autonomous mobile robot described above includes: an imaging unit capturing image data; a storage unit storing individual identification information of each of the plurality of signs and an individual actual size of each of the plurality of signs corresponding to the individual identification information; and a calculation unit detecting the first sign from the image data captured by the imaging unit, acquiring the individual identification information of the first sign, and calculating a distance to the first sign on the basis of a size of the first sign in the image data and the individual actual size of the first sign corresponding to the individual identification information of the first sign.

A second aspect of the present invention is the autonomous mobile robot according to the first aspect described above in which predetermined operations are performed in order of operation numbers set in advance on the basis of the individual identification information acquired from the first sign.

A third aspect of the present invention is the autonomous mobile robot according to the second aspect described above in which the autonomous mobile robot moves by switching a guidance target to the second sign having the individual identification information set to a next operation number when having approached to a predetermined distance from the first sign.

A fourth aspect of the present invention is the autonomous mobile robot according to the first aspect or the second aspect described above in which a shape of the first sign is a square, and in which the storage unit stores a size of one side of the first sign as the individual actual size of the actual first sign.

A fifth aspect of the present invention is the autonomous mobile robot according to the third aspect described above in which a shape of the second sign is a square, and in which the storage unit stores a size of one side of the second sign as the individual actual size of the second sign.

A sixth aspect of the present invention is the autonomous mobile robot according to any one of the first to fifth aspects described above further including a communication unit receiving the individual identification information of each of the plurality of signs and information of the individual actual size of each of the plurality of signs corresponding to the individual identification information from an external device.

A seventh aspect of the present invention is a system for controlling an autonomous mobile robot that moves by being guided by a plurality of signs that have a plurality of sizes, are aligned along a movement path, and include a first sign and a second sign. The system for controlling the autonomous mobile robot described above is a system for controlling an autonomous mobile robot including: an imaging unit capturing image data; a storage unit storing individual identification information of each of the plurality of signs and an individual actual size of each of the plurality of signs corresponding to the individual identification information; and a calculation unit detecting the first sign from the image data captured by the imaging unit, acquiring the individual identification information of the first sign, and calculating a distance to the first sign on the basis of a size of the first sign on the image data and the individual actual size of the first sign corresponding to the individual identification information of the first sign.

### Advantageous Effects of Invention

According to the present invention, an autonomous mobile robot and a system for controlling an autonomous mobile robot that can accurately calculate a distance to a sign and perform guidance control, even if signs have a plurality of types of sizes.

### BRIEF DESCRIPTION OF DRAWINGS

FIG. 1 A schematic view illustrating an autonomous mobile robot according to one embodiment of the present invention is moving, seen from above.

FIG. 2 A block diagram illustrating the configuration of an autonomous mobile robot according to one embodiment of the present invention.

FIG. 3 A front view illustrating an example of a marker of a signpost read by a signpost detecting unit according to one embodiment of the present invention.

FIG. 4 A flowchart illustrating an operation of an autonomous mobile robot according to one embodiment of the present invention.

FIG. 5 A diagram illustrating an operation table of an autonomous mobile robot according to one embodiment of the present invention.

FIG. 6 An image diagram illustrating image data captured by the autonomous mobile robot illustrated in [FIG. 1.

### DESCRIPTION OF EMBODIMENTS

Hereinafter, an embodiment of the present invention will be described with reference to the drawings. The present invention can be applied to unmanned vehicles in factories, distribution warehouses, and the like, service robots in public facilities such as facilities, halls, airports, and the like, work robots in outdoor environments in which it is difficult for a Global Positioning System (GPS) to function, and the like.

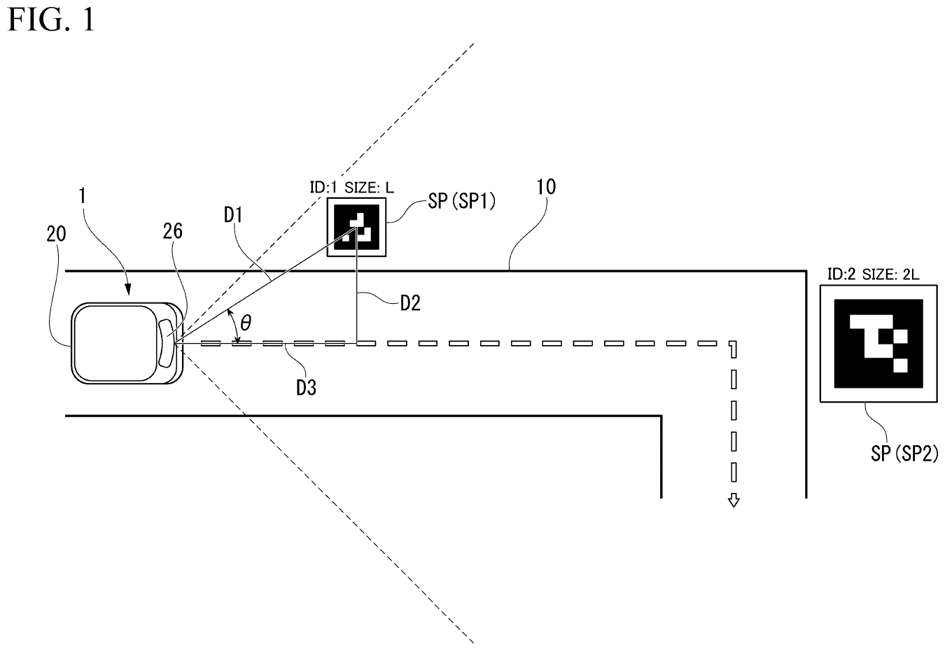

FIG. 1 is a schematic view of a view in which an autonomous mobile robot 1 according to one embodiment of the present invention is moving, seen from above. As illustrated in FIG. 1, the autonomous mobile robot 1 moves while sequentially reading a plurality of signposts SP aligned along a movement path 10 using an imaging unit 26 mounted in a robot main body 20. In other words, the autonomous mobile robot 1 is guided by a plurality of signposts SP to move along the movement path 10.

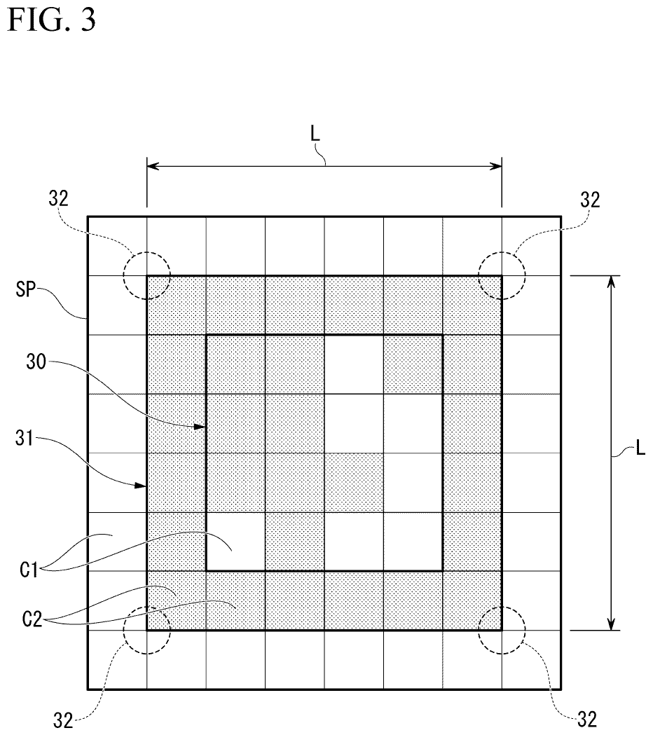

Here, “signpost” is a structure that has a marker (sign) and is placed in the movement path 10 or at a predetermined place near the movement path 10. The marker includes identification information (a pattern ID) of the structure. As illustrated in FIG. 3 to be described below, the marker according to this embodiment is formed by arranging a first cell C1, which can reflect light, and a second cell C2, which cannot reflect light, on a two-dimensional plane.

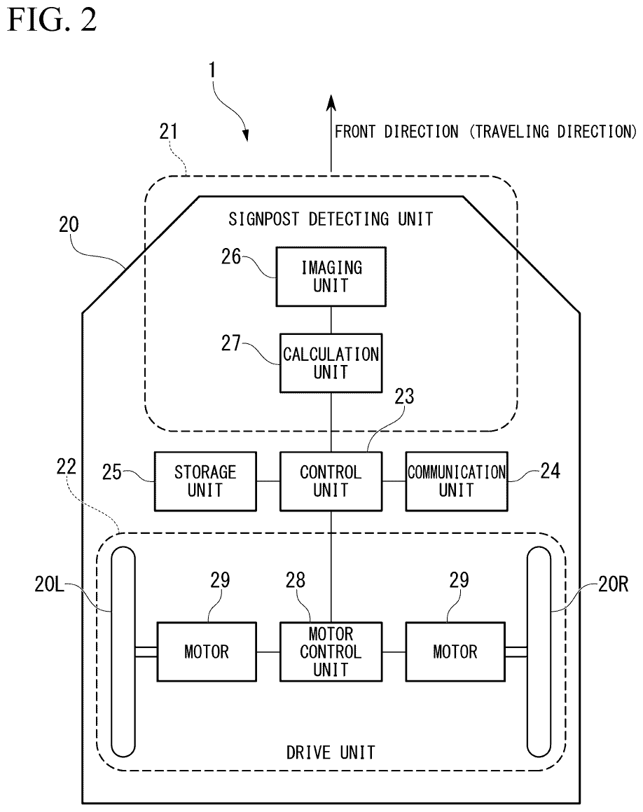

FIG. 2 is a block diagram illustrating the configuration of the autonomous mobile robot 1 according to one embodiment of the present invention. As illustrated in FIG. 2, the autonomous mobile robot 1 includes a signpost detecting unit 21, a drive unit 22, a control unit 23, a communication unit 24, and a storage unit 25.

The signpost detecting unit 21 has an imaging unit 26 and a calculation unit 27. In addition, the drive unit 22 has a motor control unit 28, two motors 29, and left and right drive wheels 20L and 20R. The configuration of the signpost detecting unit 21 and the drive unit 22 is one example, and any other configuration may be employed.

The imaging unit 26 is disposed in front of the autonomous mobile robot 1 in a traveling direction. The imaging unit 26 according to this embodiment includes a light that emits infrared LED light to the front side and a camera that images reflection light (infrared LED light) reflected by the signpost SP. The infrared LED light is suitable for dark places such as the inside of a factory, a place in which visible light is strong, and the like. For example, as the camera, a camera combined with an infrared filter is appropriate. In addition, the imaging unit 26 may be configured to emit detection light other than infrared LED light.

The calculation unit 27 forms binarized image data formed from black and white by performing a binarization process on the basis of a captured image transmitted from the imaging unit 26, detects a signpost SP using this binarized image data, and calculates at which distance (a distance D1) and in which direction (an angle θ) the signpost SP is located with respect to the autonomous mobile robot 1.

The calculation unit 27 calculates a distance D1 and an angle θ with respect to the signpost SP on the basis of the size of a marker of a signpost SP on the image data captured by the imaging unit 26 and the size of a marker of an actual signpost SP set in advance. In other words, the calculation unit 27 according to this embodiment can calculate a distance D1 and an angle θ with respect to the signpost SP by using only one camera (the imaging unit 26). In this embodiment, the size of a marker of an actual signpost SP, as will be described below, is defined as the length of one side of the marker of the signpost SP having a square shape. This length, for example, when the length (length L) of one side of a marker of a normal-sized signpost SP is set, may be set as a relative value using this length L as a reference or may be set as an absolute value (a numerical value) in units of millimeters or meters.

The drive wheel 20L is disposed on the left side in the traveling direction of the autonomous mobile robot 1. The drive wheel 20R is disposed on the right side in the traveling direction of the autonomous mobile robot 1. In addition, in order to stabilize the posture of the autonomous mobile robot 1, the autonomous mobile robot 1 may have wheels other than the drive wheels 20L and 20R. The motor 29 rotates the left and right drive wheels 20L and 20R in accordance with control of the motor control unit 28.

The motor control unit 28 supplies power to the left and right motors 29 on the basis of an angular velocity instruction value input from the control unit 23. The left and right motors 29 rotate at an angular velocity corresponding to the power supplied from the motor control unit 28, whereby the autonomous mobile robot 1 moves forward or backward. In addition, by causing a difference between angular velocities of the left and right motors 29, the traveling direction of the autonomous mobile robot 1 is changed.

The control unit 23 controls the drive unit 22 on the basis of information obtained from the signpost SP by the signpost detecting unit 21. The communication unit 24 communicates with a higher-level system (an external device) that is not illustrated in the drawing. For example, on the basis of a current position of the autonomous mobile robot 1 in the movement path 10, the higher-level system that is not illustrated in the drawing provides the autonomous mobile robot 1 with individual identification information (a pattern ID) of the signpost SP to be detected and the size of a marker of the actual signpost SP corresponding to this identification information. The storage unit 25 stores the individual identification information of the signpost SP and the size of the marker of the actual signpost SP corresponding to this identification information provided by the higher-level system.

FIG. 3 is a front view illustrating an example of a marker of a signpost SP read by the signpost detecting unit 21 according to one embodiment of the present invention. As illustrated in FIG. 3, the marker of the signpost SP is formed by arranging first cells C1, which can reflect infrared LED light, and second cells C2, which cannot reflect infrared LED light, on a two-dimensional plane.

The first cell C1, for example, is formed using a material having high reflectance for infrared LED light such as an aluminum foil, a thin film of titanium oxide, or the like. The second cell C2, for example, is formed by using a material having low reflectance for infrared LED light such as an infrared cut film, a polarizing film, an infrared absorber, black felt, or the like.

The first cell C1 and the second cell C2 are squares of the same size, and the entire marker formed using the first cells C1 and the second cells C2 is also in a square shape. The marker has an identification area 30 and a frame area 31 that surrounds the identification area 30. The identification area 30 according to this embodiment is formed from a matrix pattern of 4 rows×4 columns.

In the example illustrated in FIG. 3, when expressed using binary codes of “1” representing the first cell C1 (white) and “0 (zero)” representing the second cell C2 (black), the identification area 30 is 16-bit information. The calculation unit 27 can read the identification information (a pattern ID) of the signpost SP from the identification area 30.

The identification area 30 is not limited to the pattern of 4 rows×4 columns but may be a pattern of 3 rows×3 columns or less or 5 rows×5 columns or more.

The frame area 31 is a non-reflective frame area and is formed along only the second cells C2 (black). The frame area 31 is formed in a square frame shape surrounding the identification area 30 using the second cells C2. The calculation unit 27, for example, detects four corner portions 32 of the frame area 31 and calculates the size of the marker from the length (length L) of any one of four sides positioned between the corner portions 32.

The calculation unit 27 reads the size of an actual marker from the storage unit 25 on the basis of identification information obtained from the identification area 30 and calculates a distance D1 between the robot main body 20 and the signpost SP on the basis of the size of the marker on the image data captured by the imaging unit 26 and the stored size of an actual marker corresponding to the identification information of the marker.

In addition, the calculation unit 27 calculates center coordinates of the marker within the angle of view from the four corner portions 32 of the frame area 31. The calculation unit 27 calculates a direction (angle θ) of the signpost SP with respect to the traveling direction of the autonomous mobile robot 1 from the center coordinates.

When a distance to a signpost SP (for example, a signpost SP1) guided from this autonomous mobile robot 1 becomes shorter than a predetermined threshold set in advance, the autonomous mobile robot 1 switches its target to a next signpost SP (for example, a signpost SP2) and moves.

Next, the operation of the autonomous mobile robot 1 described above will be described more specifically. In the following description, unless otherwise indicated, calculation relating to image processing of the autonomous mobile robot 1 is performed by the calculation unit 27. Calculation relating to the driving control of the autonomous mobile robot 1 is performed by the control unit 23. In addition, although the control system including the control unit 23, the storage unit 25, the calculation unit 27, and the motor control unit 28 illustrated in FIG. 2 described above is divided into respective functions, the units may be the same control device as hardware. In other words, the following operations of the autonomous mobile robot 1 may be controlled by the same control device. The control device is a computer.

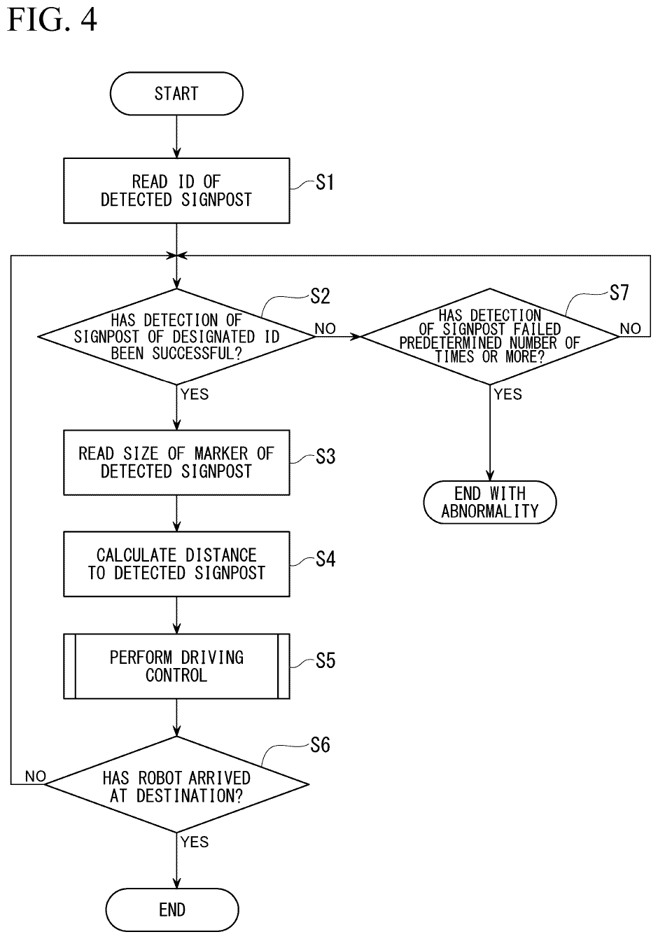

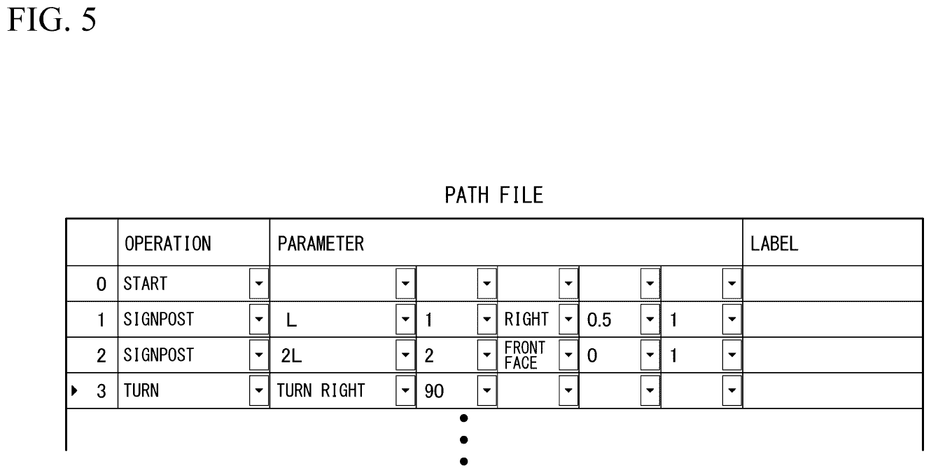

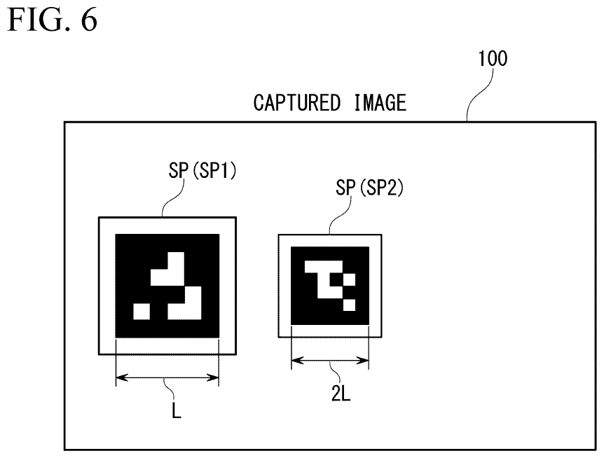

FIG. 4 is a flowchart illustrating an operation of an autonomous mobile robot 1 according to one embodiment of the present invention. FIG. 5 is a diagram illustrating an operation table of an autonomous mobile robot 1 according to one embodiment of the present invention. FIG. 6 is an image diagram illustrating image data 100 captured by the autonomous mobile robot 1 illustrated in FIG. 1. First, the operation table of the autonomous mobile robot 1 will be described. As illustrated in FIG. 5, in the operation table, a STEP input sequence in which the autonomous mobile robot 1 performs predetermined operations in order of operation numbers set in advance is stored.

A user can edit the operation table using GUI software illustrated in FIG. 5 (for example, selecting parameters of each item through pulldown). The operation table is stored in each of the autonomous mobile robot 1 and the higher-level system.

A number column at the left end of the operation table illustrated in FIG. 5 is a column of operation numbers. In other words, numbers such as 0, 1, 2, . . . are operation numbers. Items “Operation”, “Parameter”, and “Label” are associated with an operation number. In the item “Parameter”, in order from the left side, items “Signpost Size or Operation,” “Signpost No. or Rotation Angle,” “Following Direction,” “Signpost Left-Right Distance,” and “Signpost Front-Back Distance” are included. Details of respective parameters of the items will be described below in combination with the operation of the autonomous mobile robot 1.

Next, the operation of the autonomous mobile robot 1 will be described along the flowchart illustrated in FIG. 4. The autonomous mobile robot 1 executes operations in order of the operation numbers in the movement table illustrated in FIG. 5 (in order of largest to smallest number of the operation number) and reads the identification information of the signpost SP to be detected (Step S1).

Next, the autonomous mobile robot 1 detects a signpost SPI with the specified identification information (Signpost No. “1” of Operation Number “1” illustrated in FIG. 5) from the image data 100 (see FIG. 6) captured by the imaging unit 26 (Step S2). The detection of the signpost SP is executed for each frame of the image data 100 captured by the imaging unit 26.

In a case in which the signpost SPI cannot be detected (in the case of No in Step S2), the autonomous mobile robot 1 determines whether or not detection of the signpost SP1 has failed a certain number of times or more (Step S7). In the case of Yes in Step S7, the autonomous mobile robot 1 assumes (determines) that an abnormality such as a failure of the imaging unit 26, loss of the signpost SP, or the like has occurred and ends the operation.

In a case in which the signpost SPI could be detected (in the case of Yes in Step S2), the autonomous mobile robot 1 reads a size of the marker (first sign) of the actual signpost SP1 (signpost size “L” for the operation number “1” illustrated in FIG. 5) from the identification information of the signpost SP1 (Step S3). Then, the autonomous mobile robot 1 calculates a distance D1 to the signpost SP1 on the basis of the size of the marker (first sign) of the signpost SP1 on the image data 100 and the size of the marker (first sign) of the actual signpost SP1 that has been read (Step S4).

Next, the autonomous mobile robot 1 performs driving control for the operation number “1” illustrated in FIG. 5 (Step S5). In driving control set to the operation number “1”, “following direction” is “right”, “signpost left-right distance” is “0.5”, and “signpost front-back distance” is “1”. In other words, the driving control set to the operation number “1” is executed on the basis of “following direction” in which “right” is selected (set), “signpost left-right distance” in which “0.5” is selected (set), and “signpost front-back distance” in which “1” is selected (set). More specifically, the autonomous mobile robot 1 moves forward (follows) with respect to the signpost SP1 with a distance of “0.5” meters (D2=D1×sin θ (see FIG. 1)) to the “right” side.

Then, the autonomous mobile robot 1 determines whether it has approached the signpost SP1 to a distance of “1” meter on the front side in a traveling direction (D3=D1×cos θ (see FIG. 1)) (Step S6). In the case of No in Step S6, the process returns to Step S2, and the operations described above are repeated. When having approached to the distance of 1 meter from the signpost SP1, the autonomous mobile robot 1 assumes (determines) that it has reached the destination of the operation number “1”, ends the operation for the operation number “1”, and executes an operation for a next operation number “2”. On the basis of the operation for the operation number “2”, a guidance target (a target to guide the autonomous mobile robot 1) is switched to a next signpost SP2.

The operation for the operation number “2” is similar to the operation for the operation number “1” described above. First, the autonomous mobile robot 1 reads identification information of the signpost SP2 to be detected next (Step S1). Next, the autonomous mobile robot 1 detects the signpost SP2 having the specified identification information (Signpost No. “2” of the operation number “2” illustrated in FIG. 5) from the image data 100 (see FIG. 6) captured by the imaging unit 26 (Step S2).

In a case in which the signpost SP2 could be detected (in the case of Yes in Step S2), the autonomous mobile robot 1 reads a size of the marker (second sign) of the actual signpost SP2 (signpost size “2L” (=2×L) of the operation number “2” illustrated in FIG. 5) from the identification information of the signpost SP2 (Step S3). Then, the autonomous mobile robot 1 calculates a distance D1 to the signpost SP2 on the basis of the size of the marker (second sign) of the signpost SP2 on the image data 100 and the size of the marker (second sign) of the actual signpost SP2 that has been read (Step S4).

Next, the autonomous mobile robot 1 performs driving control for the operation number “2” (Step S5). In driving control set to the operation number “2”, “following direction” is “front”, “signpost left-right distance” is “0”, and “signpost front-back distance” is “1”. In other words, the driving control set to the operation number “2” is executed on the basis of “following direction” in which “front side” is selected (set), “signpost left-right distance” in which “0” is selected (set), and “signpost front-back distance” in which “1” is selected (set). More specifically, the autonomous mobile robot 1 moves forward (follows) toward “front side” of the signpost SP2 with a left-right distance of “0” meters.

Then, when having approached to the distance of “1” meter on the front side in the traveling direction from the signpost SP2, which is a destination (in the case of Yes in Step S6), the autonomous mobile robot 1 ends the operation for the operation number “2” and executes an operation for a next operation number “3”.

“Operation” set for the operation number “3” is “turn”. A parameter of “operation” of this turn is “right turn”, and a parameter of “rotation angle” is “90” degrees. In other words, as illustrated in FIG. 1, the autonomous mobile robot 1 turns right by 90 degrees in front of the signpost SP2. In this way, the autonomous mobile robot 1 moves from a predetermined start point to a predetermined goal point by executing operations in order of operation numbers in the operation table illustrated in FIG. 5.

As described above, the autonomous mobile robot 1 detects signposts SP aligned along the movement path 10 using the mounted imaging unit 26 and moves while being guided by the signposts SP. The movement path 10 of the autonomous mobile robot 1 is designated by setting relative positions relative to the signposts SP and can generate a long-distance path by installing a plurality of signposts SP along the path. In addition, by sequentially switching the signpost SP to be detected during movement of the autonomous mobile robot 1 along the path, the autonomous mobile robot I can continue traveling.

At this time, depending on the place, in a case in which the size of the signpost SP is configured to be large by widening an installation interval of signposts SP, to the contrary, the size of the signpost SP may be changed to be small such that, even when the autonomous mobile robot 1 becomes close to the signpost SP in order to allow the autonomous mobile robot 1 to approach the signpost SP, the signpost enters the angle of view of image data captured by the imaging unit (the angle of view of the camera). In this embodiment, the size of the marker of the signpost SP on the image data is set for each signpost SP detected by the imaging unit 26, and the actual size of the marker of the signpost SP can also be registered in association with the identification information of the signpost SP at the time of setting the path. Then, in a case in which a distance between the autonomous mobile robot 1 and the signpost SP can be calculated, the actual size of the marker of the signpost SP is used.

In accordance with this, as illustrated in FIG. 6, also in a case in which the marker (the first sign) of a signpost SP1 having a normal size that is close to the autonomous mobile robot 1 and the marker (the second sign) of a signpost SP2 having a large size that is far from the autonomous mobile robot 1 are simultaneously shown in the image data 100 captured by the autonomous mobile robot 1, and the markers of the two signposts SP (SP1, SP2) are displayed in the same size on the image data 100, the autonomous mobile robot 1 can accurately calculate distances to these two signposts SP (SP1, SP2) and perform guidance control. In addition, to the contrary, also in a case in which the marker of a signpost SP having a small size that is close to the autonomous mobile robot 1 and the marker of a signpost SP having a normal size that is far from the autonomous mobile robot 1 are simultaneously shown in the image data 100, and the two signposts SP are displayed in the same size on the image data 100, the autonomous mobile robot 1 can approach the signpost SP having the small size that is close to the autonomous mobile robot 1.

In this way, according to this embodiment described above, there is provided the autonomous mobile robot 1 that detects signposts SP aligned along the movement path 10 using the mounted imaging unit 26 and moves by being guided by the signposts SP, in which markers of the signposts SP have a plurality of types of sizes, and the autonomous mobile robot 1 includes the storage unit 25 that stores individual identification information of the signposts SP and sizes of markers of actual signposts SP corresponding to the identification information and the calculation unit 27 that detects a signpost SP from image data captured by the imaging unit 26 and acquires identification information of the signpost SP and calculates a distance to the signpost SP on the basis of the size of a marker of the signpost SP on the image data and the size of a marker of an actual signpost SP corresponding to the identification information. According to this configuration, although markers of signposts SP have a plurality of types of sizes, by accurately calculating a distance to a signpost SP, the autonomous mobile robot 1 can be guided and controlled.

In addition, according to the autonomous mobile robot 1 of this embodiment, predetermined operations are performed in order of operation numbers set in advance on the basis of identification information acquired from the signpost SP. According to this configuration, since predetermined operations are performed in order of the operation numbers, and thus high-level knowledge and complicated efforts are not necessary for setting the operations.

In addition, according to the autonomous mobile robot 1 of this embodiment, when having approached to a predetermined distance from the sign described above, the autonomous mobile robot 1 moves by switching the guidance target to a next sign described above having the above-described identification information set to a next operation number. According to this configuration, by installing a plurality of signposts SP along a path, a long-distance path can be generated.

In addition, according to the autonomous mobile robot 1 of this embodiment, the marker of the signpost SP has a square shape, and the storage unit 25 stores a size of one side of the marker of the signpost SP as the size of the marker of the actual signpost SP. According to this configuration, the information relating to the size of the marker of the signpost SP becomes small, and the storage volume and the arithmetic operation processing amount may be small.

In addition, according to the autonomous mobile robot 1 of this embodiment, a communication unit receiving identification information and the information of the size of the marker of the actual signpost SP corresponding to the identification information from a higher-level system is included. According to this configuration, the setting is completed by editing the operation table illustrated in FIG. 5 using input from a PC or the like, and thus high-level knowledge and complicated efforts are not required in changing the setting of the movement path 10.

In addition, according to the system for controlling the autonomous mobile robot 1 described above, operations and effects similar to the operations and the effects described above can be acquired.

Furthermore, the autonomous mobile robot 1 and the system for controlling the autonomous mobile robot 1 can also be described as below. Also according to an autonomous mobile robot 1 and a system for controlling the autonomous mobile robot 1 to be described below, similar to the autonomous mobile robot 1 and the system for controlling the autonomous mobile robot 1, operations and effects similar to the operations and the effects described above can be acquired.

The autonomous mobile robot is an autonomous mobile robot that moves by being guided by a plurality of signs that have a plurality of types of sizes, are aligned along a movement path, and includes a first sign and a second sign, the autonomous mobile robot including: an imaging unit capturing image data; a storage unit storing individual identification information of each of the plurality of signs and an individual actual size of each of the plurality of signs corresponding to the individual identification information; and a calculation unit detecting the first sign from the image data captured by the imaging unit, acquiring the individual identification information of the first sign, and calculating a distance to the first sign on the basis of a size of the first sign on the image data and the individual actual size of the first sign corresponding to the individual identification information of the first sign.

In the autonomous mobile robot, predetermined operations are performed in order of operation numbers set in advance on the basis of the individual identification information acquired from the first sign.

In the autonomous mobile robot, the autonomous mobile robot moves by switching a guidance target to the second sign having the individual identification information set to a next operation number when having approached to a predetermined distance from the first sign up.

In the autonomous mobile robot, a shape of the first sign is a square, and the storage unit stores a size of one side of the first sign as the individual actual size of the first sign.

In the autonomous mobile robot, a shape of the second sign is a square, and the storage unit stores a size of one side of the second sign as the individual actual size of the second sign.

The autonomous mobile robot further includes a communication unit receiving the individual identification information of each of the plurality of signs and information of the individual actual size of each of the plurality of signs corresponding to the individual identification information from an external device.

The system for controlling an autonomous mobile robot is a system for controlling an autonomous mobile robot that moves by being guided by a plurality of signs that have a plurality of sizes, are aligned along a movement path, and includes a first sign and a second sign, the system for controlling the autonomous mobile robot including: an imaging unit capturing image data; a storage unit storing individual identification information of each of the plurality of signs and an individual actual size of each of the plurality of signs corresponding to the individual identification information; and a calculation unit detecting the first sign from the image data captured by the imaging unit, acquiring the individual identification information of the first sign, and calculating a distance to the first sign on the basis of a size of the first sign on the image data and the individual actual size of the first sign corresponding to the individual identification information of the first sign.

As above, although a preferred embodiment of the present invention has been described with reference to the drawings, the present invention is not limited to the embodiment described above. The shapes and combinations of respective constituent members represented in the embodiment described are examples, and various modifications can be made on the basis of a design requirement and the like in a range not departing from the main idea of the present invention.

For example, a registered (stored) size of a marker of a signpost SP can be set to a ratio higher than a normal individual difference of human's faces as a ratio using the marker of a normal signpost SP as a reference. In other words, the sizes of markers of signposts SP registered (stored) in the storage unit 25 may be set such that the ratio of a small size to a normal size in markers of signposts SP is lower than a ratio of a small size to a normal size (in the range of a normal individual difference) in faces of persons. In addition, the sizes of markers of signposts SP registered (stored) in the storage unit 25 may be set such that the ratio of a large size to a normal size in markers of signposts SP is higher than a ratio of a large size to a normal size (in the range of a normal individual difference) in faces of persons. For example, in a case in which the size of a marker of a normal signpost SP is “L”, the size of a marker of a signpost SP registered in the storage unit 25 can be set to be ½ times (0.5L) or less or twice thereof (2L) or more, set to 1.5 times thereof (0.2L) or less or 5 times thereof (5L) or more, and set to 1/10 times thereof (0.1L) or less or 10 times thereof (10L) or more.

For example, in the embodiment described above, although a configuration in which the autonomous mobile robot 1 is a vehicle has been described, the autonomous mobile robot 1 may be a flying body collectively called a drone or the like. In addition, for example, in the embodiment described above, although a configuration in which a plurality of signposts SP are aligned along the movement path 10 has been described, a configuration in which only one signpost SP is disposed may be employed.

### Industrial Applicability

According to the present invention, an autonomous mobile robot and a system for controlling an autonomous mobile robot that can accurately calculate a distance to a sign and perform guidance control, even if signs have a plurality of types of sizes.

### REFERENCE SIGNS LIST

1 Autonomous mobile robot
10 Movement path
20 Robot main body
20L Drive wheel
20R Drive wheel
21 Signpost detecting unit
22 Drive unit
23 Control unit
24 Communication unit
25 Storage unit
26 Imaging unit
27 Calculation unit
28 Motor control unit
29 Motor
30 Identification arca
31 Frame area
32 Corner portion
100 Image data
C1 First cell
C2 Second Cell
D1 Distance
SP Signpost
SP1 Signpost
SP2 Signpost
θ Angle

1. An autonomous mobile robot that moves by being guided by a plurality of signs that have a plurality of types of sizes, are aligned along a movement path, and include a first sign and a second sign, the autonomous mobile robot comprising:
an imaging unit capturing image data;
a storage unit storing individual identification information of each of the plurality of signs and an individual actual size of each of the plurality of signs corresponding to the individual identification information; and
a calculation unit detecting the first sign from the image data captured by the imaging unit, acquiring the individual identification information of the first sign, and calculating a distance to the first sign on the basis of a size of the first sign in the image data and the individual actual size of the first sign corresponding to the individual identification information of the first sign.

2. The autonomous mobile robot according to claim 1, wherein predetermined operations are performed in order of operation numbers set in advance on the basis of the individual identification information acquired from the first sign.

3. The autonomous mobile robot according to claim 2, wherein the autonomous mobile robot moves by switching a guidance target to the second sign having the individual identification information set to a next operation number when having approached to a predetermined distance from the first sign.

4. The autonomous mobile robot according to claim 1,
wherein a shape of the first sign is a square, and
wherein the storage unit stores a size of one side of the first sign as the individual actual size of the first sign.

5. The autonomous mobile robot according to claim 3,
wherein a shape of the second sign is a square, and
wherein the storage unit stores a size of one side of the second sign as the individual actual size of the second sign.

6. The autonomous mobile robot according to claim 1, further comprising:
a communication unit receiving the individual identification information of each of the plurality of signs and information of the individual actual size of each of the plurality of signs corresponding to the individual identification information from an external device.

7. A system for controlling an autonomous mobile robot that moves by being guided by a plurality of signs that have a plurality of sizes, are aligned along a movement path, and include a first sign and a second sign, the system for controlling the autonomous mobile robot comprising:
an imaging unit capturing image data;
a storage unit storing individual identification information of each of the plurality of signs and an individual actual size of each of the plurality of signs corresponding to the individual identification information; and
a calculation unit detecting the first sign from the image data captured by the imaging unit, acquiring the individual identification information of the first sign, and calculating a distance to the first sign on the basis of a size of the first sign in the image data and the individual actual size of the first sign corresponding to the individual identification information of the first sign.
